(19) United States
(12) Patent Application Publication
(10) Pub. No.: US 2007/0200799 A1
(43) Pub. Date: Aug. 30, 2007

(54) Flat panel display device

(75) Inventors: Hideaki Ohki, Tokyo (JP); Akira Otsuka, Zama (JP); Sojiro Hagihara, Yokohama (JP); Takashi Shiizaki, Yokohama (JP); Makoto Onozawa, Yokohama (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/602,193

(22) Filed: Nov. 21, 2006

(30) Foreign Application Priority Data
Feb. 24, 2006 (JP) 2006-049052

(51) Int. Cl. G09G 3/28

(52) U.S. Cl. 345/68

(57) ABSTRACT

A flat panel display device includes switching elements QA3 and QA4, respectively connected to a voltage Vs and ground to be applied to a panel capacitance Cp when performing light emission relating to image display, for clamping the voltage of the panel capacitance; coils LA1 and LA2 each having one end connected to the panel capacitance; a path separation circuit DLA1 and DLA2, connected to the other ends of the coils, for separating paths through which charge/discharge currents flow; a switching element QA1 connected between the voltage Vs and the path separation circuit; a switching element QA2 connected between the ground and the path separation circuit; and diodes connected in parallel to the switching elements, in which the resonance reference voltage relating to a power recovery operation is set to a maximum voltage and a minimum voltage to be applied to the panel capacitance, and the paths through which the charge/discharge currents flow are separated to thereby improve the recovery efficiency in a power recovery circuit and enable realization of stable image display operation.

### CROSS-REFERENCE TO RELATED APPLICATIONS

This application is based upon and claims the benefit of priority from the prior Japanese Patent Application No. 2006-049052, filed on Feb. 24, 2006, the entire contents of which are incorporated herein by reference.

### BACKGROUND OF THE INVENTION

1. Field of the Invention

The present invention relates to a flat panel display device using a capacitive load as a display means.

2. Description of the Related Art

In a display device such as a plasma display device and an Electro Luminescence display device, a power recovery circuit for recovering a charge/discharge power of a capacitive load being a display means is provided. The power recovery circuit is used to recover the charge/discharge power of the capacitive load relating to image display so as to reduce the power consumption (see, for example, Patent Documents 1 to 3).

FIG. 7A is a diagram showing a drive circuit of a conventional plasma display device, showing a sustain circuit in the drive circuit. The sustain circuit is a circuit for generating the sustain pulse shown in FIG. 7B to be applied to a capacitive load being a display means. Every time the sustain pulse is applied, sustain discharge is performed between electrodes of the capacitive load selected according to the image to be displayed to emit light to thereby display the image.

The configuration of the sustain circuit relating to one electrode (first electrode) of two electrodes of the panel capacitance Cp is shown in FIG. 7A, and this also applies to the other electrode (second electrode). The panel capacitance Cp is a capacitive load being a display means. Besides, transistors QC1, QC2, QC3, and QC4 are N-channel MOS field effect transistors (FETs).

A capacitance CC1 is connected between the interconnection point between the drain of the transistor QC1 and the source of the transistor QC2 and the ground (GND). The source of the transistor QC1 is connected to the anode of a diode DC1, and the drain of the transistor QC2 is connected to the cathode of a diode DC2.

A coil LC1 is connected between the first electrode of the panel capacitance Cp and the cathode of the diode DC1. A coil LC2 is connected between the first electrode of the panel capacitance Cp and the anode of a diode DC2. Diodes DC5 and DC6 are connected in series between the voltage Vs and the ground, and the interconnection point between the diodes DC5 and DC6 is connected to the interconnection point between the coil LC1 and the cathode of the diode DC1. Diodes DC7 and DC8 are connected in series between the voltage Vs and the ground, and the interconnection point between the diodes DC7 and DC8 is connected to the interconnection point between the coil LC2 and the anode of the diode DC2.

The coils LC1 and LC2, the transistors QC1 and QC2, the diodes DC1, DC2, and DC5 to DC8, and the capacitance CC1 constitute the power recovery circuit.

The transistor QC3 has the drain connected to the voltage Vs and the source connected to the first electrode of the panel capacitance Cp. The diode DC3 is connected between the drain and the source of the transistor QC3. The transistor QC4 has the drain connected to the first electrode of the panel capacitance Cp and the source connected to the ground. The diode DC4 is connected between the drain and the source of the transistor QC4.

FIG. 7B is a diagram showing the sustain pulse generated by the sustain circuit shown in FIG. 7A. In FIG. 7B, the sustain voltage is a voltage to be applied to the first electrode of the panel capacitance Cp, and the coil current is current flowing through the coils LC1 and LC2 in the sustain circuit. For the sustain voltage, a case assuming that no loss occurs in the circuit is shown by a broken line.

At time T11, when the transistor QC1 is turned on, the charges charged at the capacitance CC1 are supplied to the panel capacitance Cp by LC resonance. In other words, the recovered power is discharged so that the voltage at the first electrode of the panel capacitance Cp rises from the ground level. At time T12, when the transistor QC1 is turned off and the transistor QC3 is turned on, the first electrode of the panel capacitance Cp is clamped at the voltage Vs. At time T13, the transistor QC3 is turned off.

At time T14, when the transistor QC2 is turned on, the charges charged at the panel capacitance Cp are supplied to the capacitance CC1 by LC resonance. In other words, the power at the panel capacitance Cp is recovered into the capacitance CC1 so that the voltage at the first electrode of the panel capacitance Cp drops from Vs. At time T15, when the transistor QC2 is turned off and the transistor QC4 is turned on, the first electrode of the panel capacitance Cp is clamped at the ground level. At time T16, the transistor QC4 is turned off. Thereafter, the operations at time T11 to T16 are repeated.

### (Patent Document 1)

Japanese Patent Application Laid-open No. Hei 11

### (Patent Document 2)

Japanese Patent Application Laid-open No. Sho 61

### (Patent Document 3)

Japanese Patent Application Laid-open No. Hei 5

The power recovery operation of the conventional drive circuit as shown in FIG. 7A and FIG. 7B has the following problem because the resonance reference voltage of the power recovery circuit is set to a (½) voltage of the voltage to be applied to the capacitive load for performing light emission and the recovery operation period is set to less than (½) the resonance cycle of the power recovery circuit.

In the power recovery circuit shown in FIG. 7A, a sustain discharge may occur during voltage rise because the gradient of the voltage rise is gentle in the vicinity of the potential to be reached by LC resonance. As a result, the discharge may vary depending on a discharge cell (panel capacitance Cp: capacitive load being a display means) and the discharge may be unstable.

Since the potential to be reached by LC resonance is low due to the resistance component or the like in the power recovery circuit, a voltage is steeply applied to the panel capacitance Cp up to the sustain discharge voltage Vs by the clamping transistor as shown in FIG. 7B. The application of such steep voltage pulse increases the radiation noise.

If the voltage to be applied to the panel capacitance Cp is increased to the sustain discharge voltage Vs by the clamping transistor, the on-resistance and the voltage drop resulting therefrom increase because a discharge current flows immediately after the turning-on of the clamping transistor. This causes a decrease in brightness and a decrease in voltage margin, resulting in unstable discharge.

### SUMMARY OF THE INVENTION

An object of the present invention is to provide a flat panel display device in which the recovery efficiency in the power recovery circuit is improved and which is capable of stable image display operation.

A plasma display device of the present invention includes a self-luminous display panel for applying a voltage to a capacitive load being a display means to perform image display and a drive circuit for applying a voltage to the capacitive load. The drive circuit includes a first and a second switching element, connected to a first voltage and a second voltage, for clamping an electrode of the capacitive load to the first voltage and the second voltage; a first and a second coil having one ends connected to interconnection points between the first and second switching elements and the electrode of the capacitive load; a path separation circuit, connected to other ends of the first and second coils, for separating paths through which charge/discharge currents flow; a third switching element connected between the first voltage and the path separation circuit; a fourth switching element connected between the second voltage and the path separation circuit; and a first to a fourth diode respectively corresponding to the first to fourth switching elements and connected in parallel to the switching elements, wherein the first and second voltages are a maximum voltage and a minimum voltage, respectively, to be applied to the capacitive load when performing light emission relating to the image display.

### BRIEF DESCRIPTION OF THE DRAWINGS

FIG. 1 is a diagram showing a configuration example of a plasma display device in a first embodiment;

FIG. 2 is a diagram an example of a drive waveform of the plasma display device shown in FIG. 1;

FIG. 3 is a circuit diagram showing a configuration example of a drive circuit in the first embodiment;

FIG. 4 is a diagram for explaining a driving method relating to application of a sustain pulse by the drive circuit shown in FIG. 3;

FIGS. 5A and 5B are circuit diagrams showing other configuration examples of the drive circuit in the first embodiment;

FIG. 6 is a circuit diagram showing a configuration example of a drive circuit in a second embodiment;

FIGS. 7A and 7B are diagrams for explaining a conventional drive circuit;

FIG. 8 is a diagram showing a configuration example of a drive circuit in a third embodiment;

FIG. 9 is a diagram showing a configuration example of a drive circuit in a fourth embodiment;

FIG. 10 is a diagram showing a configuration example of a drive circuit in a fifth embodiment;

FIG. 11 is a diagram showing a configuration example of a drive circuit in a sixth embodiment;

FIG. 12 is a diagram showing a configuration example of a drive circuit in a seventh embodiment; and

FIG. 13 is a diagram showing a configuration example of a drive circuit in an eighth embodiment.

### DETAILED DESCRIPTION OF THE PREFERRED EMBODIMENTS

Hereinafter, embodiments of the present invention will be described with reference to the drawings.

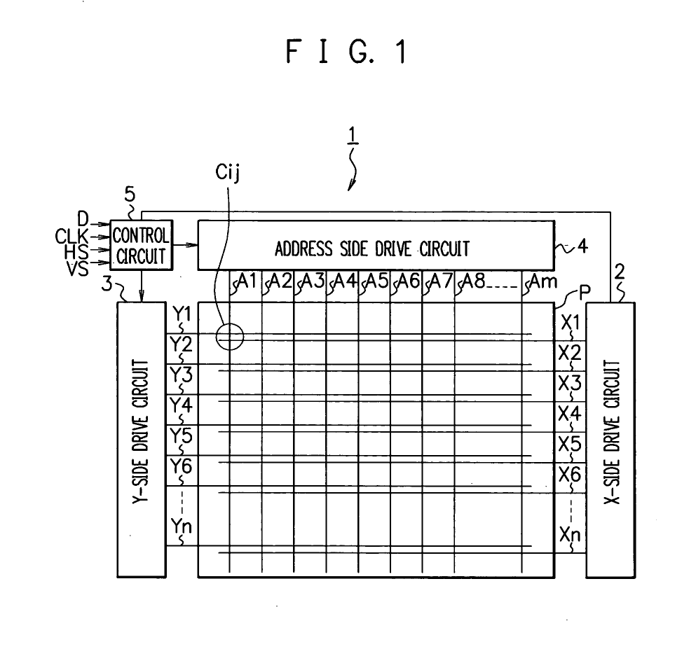

The embodiments of the present invention are applicable to a self-luminous flat panel display device using capacitive loads arranged in a matrix form as display means, such as a plasma display device, an Electro Luminescence display and so on. In the following, a case will be described in which the present invention is applied to an AC-plasma display device 1 whose entire configuration is shown in FIG. 1.

### First Embodiment

FIG. 1 is a diagram showing a configuration example of the plasma display device 1 employing the flat panel display device according to a first embodiment of the present invention. The plasma display device 1 in this embodiment has a display panel (plasma display panel) P, an X-side drive circuit 2, a Y-side drive circuit 3, an address side drive circuit 4, and a control circuit 5.

In the display panel P, X electrodes (sustain electrodes) X1, X2, . . . , Xn and Y electrodes (scan electrodes) Y1, Y2, . . . , Yn, which are parallel to each other, are provided on a first substrate, and address electrodes A1, A2, . . . , Am are provided on a second substrate which is opposed to the first substrate. Hereinafter, each of the X electrodes X1, X2, . . . , Xn or their generic name is referred to as an X electrode Xi, and each of the Y electrodes Y1, Y2, . . . , Yn or their generic name is referred to as a Y electrode Yi, i representing a suffix. Hereinafter, each of the address electrodes A1, A2, . . . , Am or their generic name is referred to as an address electrode Aj, j representing a suffix.

The X electrodes Xi and the Y electrodes Yi are arranged alternately and parallel to each other, and the address electrodes Aj are arranged in a direction perpendicular to the electrodes Xi and Yi (in a manner to intersect therewith). In the display panel P, the X electrodes Xi and the Y electrodes Yi form rows extending in the horizontal direction, and the address electrodes Aj form columns extending in the vertical direction.

The display panel P includes a plurality of display cells arranged in a matrix form with n rows and m columns. Display cells Cij are formed of intersections of the Y electrodes Yi and the address electrodes Aj and the X electrodes Xi correspondingly adjacent thereto. The display cells Cij correspond to pixels, so that the display panel P can display a two-dimensional image.

Each X electrode Xi is connected to the output terminal of the X-side drive circuit 2 which supplies a predetermined voltage (drive pulse) to the X electrode Xi. Each Y electrode Yi is connected to the output terminal of the Y-side drive circuit 3 which supplies a predetermined voltage (drive pulse) to the Y electrode Yi. Each address electrode Aj is connected to the output terminal of the address side drive circuit 4 which applies a predetermined voltage (drive pulse) to the address electrode Aj.

The X-side drive circuit 2 is composed of a circuit which repeats discharge, and the Y-side drive circuit 3 is composed of a circuit which performs line-sequential scanning and a circuit which repeats discharge. The address side drive circuit 4 is composed of a circuit which selects a column to be displayed. The X-side drive circuit 2, the Y-side drive circuit 3, and the address side drive circuit 4 are controlled by control signals supplied from the control circuit 5. The circuit for performing line-sequential scanning in the Y-side drive circuit 3 and the address side drive circuit 4 determine which cell is to be turned on, and the X-side drive circuit 2 and the circuit for repeating discharge in the Y-side drive circuit 3 repeat discharge to perform display operation in the plasma display device.

The control circuit 5 generates the control signals based on display data D, a clock CLK indicating the timing for reading the display data D, a horizontal synchronization signal HS, and a vertical synchronization signal VS from the outside, and supplies the signals to the X-side drive circuit 2, the Y-side drive circuit 3, and the address side drive circuit 4.

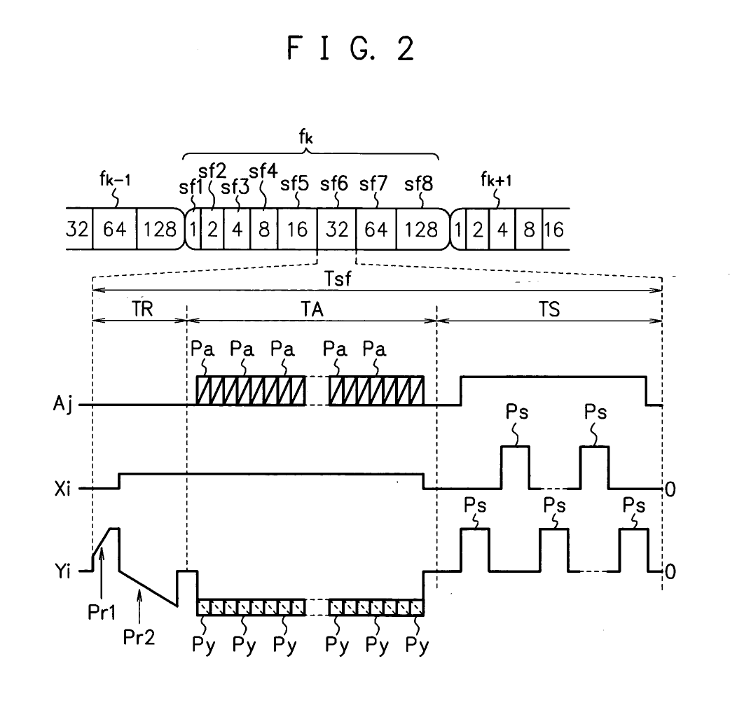

FIG. 2 is a diagram showing an example of the drive waveform of the plasma display device 1 shown in FIG. 1. An image is composed of a plurality of frames f (its suffix representing a display order) in time series such as frames fk-1, fk, fk+1 and so on shown in FIG. 2. In image display, each frame f is divided, for example, into eight sub-frames sf1, sf2, sf3, sf4, sf5, sf6, sf7, and sf8 since tone reproduction is performed by binary lighting control pixel by pixel. The sub-frames sf1 to sf8 are weighted so that the relative ratio in brightness is about 1:2:4:8:16:32:64:128, and the number of times of lighting sustain discharge of each of the sub-frames sf1 to sf8 is set.

A sub-frame period Tsf allocated to each of the sub-frames sf1 to sf8 is composed of a reset period TR, an address period TA, and a sustain discharge period TS. During the reset period TR, the display cell Cij is initialized. During the reset period TR, a positive ramp wave (a waveform having a positive slope) Pr1 is applied to the Y electrodes Yi all at once to form wall charges, and a negative ramp wave (a waveform having a negative slope) Pr2 is then applied to them all at once to adjust the amounts of wall charges of the display cells Cij.

During the address period TA, emission or non-emission of each display cell Cij can be selected by discharge between the address electrode Aj and the Y electrode Yi and discharge between the X electrode Xi and the Y electrode Yi accompanying to the former discharge. More specifically, a scan pulse Py is applied to the Y electrodes Y1, Y2, Y3, . . . in sequence, and an address pulse Pa is applied to the address electrode Aj in correspondence with the scan pulse Py, whereby discharge occurs between the address electrode Aj and the Y electrode Yi. This discharge forms wall charges at the X electrode Xi and the Y electrode Yi, so that emission or non-emission of a desired display cell Cij can be selected.

During the sustain period TS, sustain discharge is performed between the X electrode Xi and the Y electrode Yi of the selected display cell Cij to emit light. During the sustain period TS, the sustain pulse Ps is alternately applied to the X electrode Xi and the Y electrode Yi. Every time the sustain pulse Ps is applied, discharge occurs in the display cell where the wall charges are formed during the address period TA to cause the display cell to emit light. The sustain pulse Ps is a pulse of 0V or a voltage Vs.

Note that the drive waveform shown in FIG. 2 is one example, and the drive waveform is not limited to this but can be variously changed.

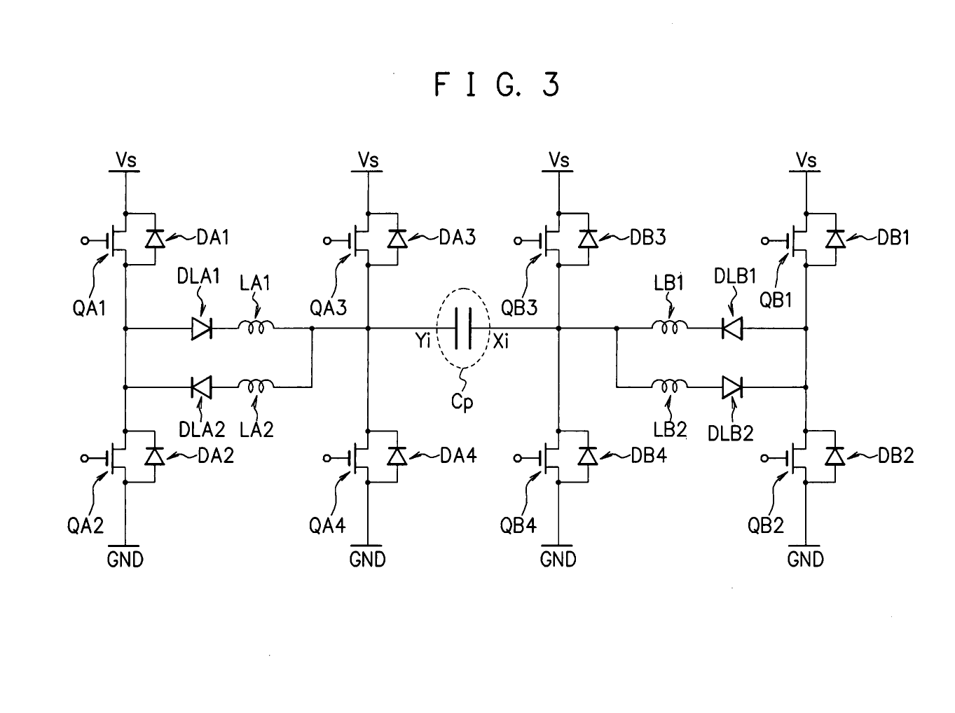

FIG. 3 is a circuit diagram showing a configuration example of the X-side drive circuit 2 and the Y-side drive circuit 3 shown in FIG. 1. FIG. 3 illustrates only each sustain circuit in the drive circuits 2 and 3. The sustain circuit is a circuit for generating the sustain pulse Ps.

In FIG. 3, a panel capacitance Cp is a capacitance between the X electrode Xi and the Y electrode Yi and corresponds to the capacitive load that is the display means. Transistors QA1, QA2, QA3, QA4, QB1, QB2, QB3, and QB4 are N-channel MOS field effect transistors each functioning as a switching element.

The sustain circuit in the Y-side drive circuit 3 will be described.

The transistor QA1 has the drain connected to the voltage Vs and the source connected to the drain of the transistor QA2. The source of the transistor QA2 is connected to the ground. Further, diodes DA1 and DA2 are connected in parallel to the transistors QA1 and QA2, respectively. More specifically, the diode DA1 has the cathode connected to the drain of the transistor QA1 and the anode connected to the source of the transistor QA1. The diode DA2 has the cathode connected to the drain of the transistor QA2 and the anode connected to the source of the transistor QA2.

The anode of a diode DLA1 is connected to the interconnection point between the source of the transistor QA1 and the drain of the transistor QA2. A coil LA1 is connected in series between the Y electrode Yi and the cathode of the diode DLA1. In other words, the diode DLA1 is connected in series to the coil LA1 such that electric current flows in a direction in which the current flows into the panel capacitance Cp (display panel).

The cathode of a diode DLA2 is connected to the interconnection point between the source of the transistor QA1 and the drain of the transistor QA2. A coil LA2 is connected in series between the Y electrode Yi and the anode of the diode DLA2. In other words, the diode DLA2 is connected in series to the coil LA2 such that electric current flows in a direction in which the current flows from the panel capacitance Cp (display panel).

The diodes DLA1 and DLA2 constitute a circuit for separating the paths through which the charge/discharge currents for the panel capacitance Cp flow.

The transistor QA3 has the drain connected to the voltage Vs and the source connected to the Y electrode Yi. The transistor QA4 has the drain connected to the Y electrode Yi and the source connected to the ground. Further, diodes DA3 and DA4 are connected in parallel to the transistors QA3 and QA4, respectively. More specifically, the diode DA3 has the cathode connected to the drain of the transistor QA3 and the anode connected to the source of the transistor QA3. The diode DA4 has the cathode connected to the drain of the transistor QA4 and the anode connected to the source of the transistor QA4. The transistors QA3 and QA4 can clamp the Y electrode Yi at the voltage Vs and 0V, respectively.

The description of the sustain circuit in the X-side drive circuit 2 will be omitted because it is configured similarly to the sustain circuit in the Y-side drive circuit 3 such that the transistors QB1 to QB4, coils LB1 and LB2, and diodes DB1 to DB4, DLB1 and DLB2 correspond to the transistors QA1 to QA4, coils LA1 and LA2, and diodes DA1 to DA4, DLA1 and DLA2, respectively.

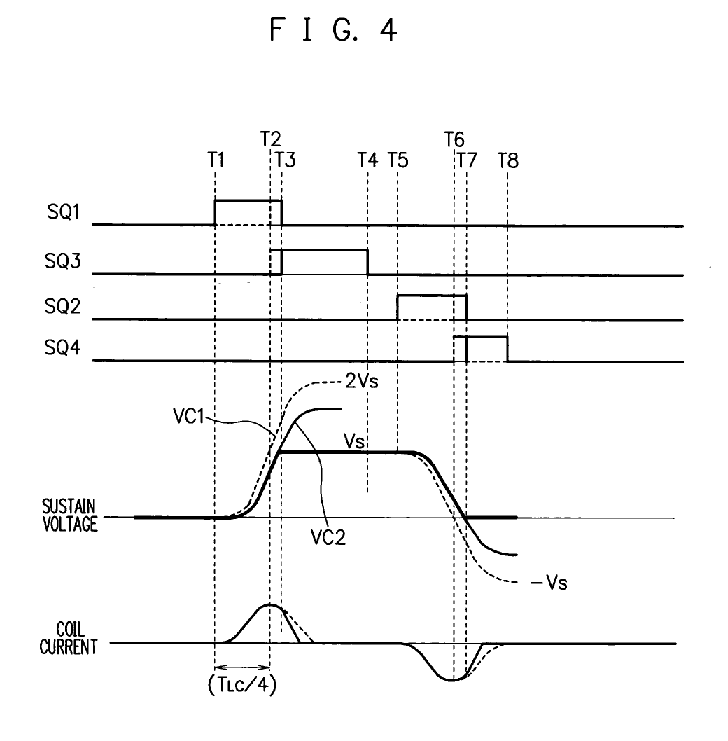

FIG. 4 is a diagram for explaining a driving method relating to application of the sustain pulse Ps by the drive circuit shown in FIG. 3. FIG. 4 shows the application to any one of electrodes of the panel capacitance Cp. Signals SQ1, SQ2, SQ3, and SQ4 show signals to be applied to gates of a set of the transistors QA1, QA2, QA3, and QA4, or a set of the transistors QB1, QB2, QB3, and QB4.

The sustain voltage is applied to one of the electrodes of the panel capacitance Cp, and the coil current is current flowing through the coil in the drive circuit. For the sustain voltage, a case with a loss due to a resistance component in the circuit is shown by a solid line VC2, and a case assuming that no loss occurs in the circuit is shown by a broken line VC1. Likewise, for the coil current, a case with a loss in the circuit is shown by a solid line, and a case with no loss in the circuit is shown by a broken line.

Hereinafter, as an example, the operation of the Y-side drive circuit 3 will be described, i.e. assuming that the signals SQ1 to SQ4 are applied to the gates of the transistors QA1 to QA4, respectively.

First, the operation when the sustain discharge voltage Vs is applied to the panel capacitance Cp (Y electrode Yi), that is, at the time of application of a high voltage will be described.

At time T1, when the transistor QA1 is turned on, the charges charged at the capacitor at the power supply Vs are discharged and supplied to the panel capacitance Cp by LC resonance. In other words, the power recovered is discharged so that the voltage of the Y electrode Yi rises from the ground. If there is no loss in the circuit, as shown by the broken line VC1, the potential of the Y electrode Yi reaches the sustain discharge voltage Vs by LC resonance at time T2, after a lapse of ¼ of the resonance cycle (T_{LC}/4 (π/2)) of the power recovery circuit from time T1. However, as shown by the solid line VC2, the potential of the Y electrode Yi reaches the sustain discharge voltage Vs by LC resonance at time T3 a predetermined time later than time T2 because there is a loss in the circuit.

Hence, in this embodiment, the transistor QA1 is turned off and the transistor QA3 is turned on, not at time T2 but at time T3 when the potential reaches the sustain discharge voltage Vs by LC resonance. Thereby, the Y electrode Yi is clamped at the voltage Vs and maintained at the voltage Vs thereafter. At time T4, the transistor QA3 is turned off.

Application of the sustain discharge voltage Vs to the Y electrode Yi in the above manner ensures that its potential reaches the sustain discharge voltage Vs when the voltage rise gradient is maximum, and that stable discharge is performed after the potential reaches the sustain discharge voltage Vs as shown in FIG. 4. At the time when the potential reaches the sustain discharge voltage Vs, sufficient current flows through the coil LA1 being a resonance coil, so that the current can also be supplied as a light-emitting discharge current (sustain discharge current). For example, even if the on-resistance of the switching element QA3 is large, stable discharge can be realized because the current can be supplied from the coil LA1.

Next, the operation when the potential of the panel capacitance Cp (Y electrode Yi) is brought from the sustain discharge voltage Vs to the ground level, that is, at the time of application of a low voltage will be described.

In the state where the Y electrode Yi is at the voltage Vs, at time T5, when the transistor QA2 is turned on, the charges charged at the panel capacitance Cp are supplied to the capacitor at the power supply Vs by LC resonance. In other words, the power at the panel capacitance Cp is recovered so that the voltage of the Y electrode Yi drops from the Vs. If there is no loss in the circuit, as shown by the broken line VC1, the potential of the Y electrode Yi reaches the ground level (0V) by LC resonance at time T6, after a lapse of ¼ of the resonance cycle of the power recovery circuit from time T5. However, as shown by the solid line VC2, the potential of the Y electrode Yi reaches the ground level at time T7 a predetermined time later than time T6 because there is a loss in the circuit.

Accordingly, the transistor QA2 is turned off and the transistor QA4 is turned on, not at time T6 but at time T7 when the potential of the Y electrode Yi reaches the ground level by LC resonance. Thereby, the Y electrode Yi is clamped at the ground level and maintained at that level thereafter. At time T8, the transistor QA4 is turned off.

The operation similar to that at times T1 to T8 shown in FIG. 4 is repeated alternately by the X-side drive circuit 2 and the Y-side drive circuit 3, whereby the operation during the sustain period TS shown in FIG. 2 is realized.

The time T3 when the potential of the electrode Xi or Yi reaches the sustain discharge voltage Vs by LC resonance and time T7 when the potential of the electrode Xi or Yi drops to the ground level can be found in advance from the circuit characteristics and the like of the drive circuits for use. While the on/off control of the transistor being the switching element is performed when the potential of the electrode Xi or Yi reaches the sustain discharge voltage Vs or the ground level by LC resonance in the above description, the potential of the electrode Xi or Yi does not always need to precisely match the sustain discharge voltage Vs or the ground level. The on/off control of the transistor may be performed, for example, when the potential of the electrode Xi or Yi substantially reaches the sustain discharge voltage Vs or the ground level. Further, the on/off control of the transistor may be performed at time later than the time point when the potential of the electrode Xi or Yi reaches the sustain discharge voltage Vs, and in this case the discharge current can be supplied from the coil.

It is not always necessary to turn on the transistor QA3 (QB3) concurrently with turning off of the transistor QA1 (QB1), but the transistor QA3 (QB3) can be turned on after the transistor QA1 (QB1) is turned off and before the diode DA1 (DB1) is turned on. This also applies to the on/off control relating to the transistor QA2 (QB2) and the transistor QA4 (QB4).

According to the first embodiment, the resonance reference voltage relating to the power recovery operation is set to maximum (voltage Vs) and minimum (0V) of the voltage to be applied to the panel capacitance Cp, and the paths (input/output paths of the recovery current) through which the charge/discharge currents flow are separated.

This allows the voltage supplied to the panel capacitance Cp to reach the sustain discharge voltage Vs when the gradient of voltage rise is maximum, so that the discharge becomes stable after the voltage reaches the sustain discharge voltage Vs. At the time when the voltage reaches the sustain discharge voltage Vs, sufficient current flows through the resonance coil (LA1 or LB1) which can be supplied as the light-emitting discharge current (sustain discharge current). For example, even if the on-resistance of the switching element for clamping at the sustain discharge voltage Vs is large, stable discharge can be realized because the current can be supplied from the resonance coil. Accordingly, stable image display operation can be realized, resulting in improved performance and increased fabrication yield.

By separating the paths through which the charge/discharge currents flow, the circuit characteristics (for example, resonance cycle) of the power recovery circuit in voltage rise/drop can be independently set, when necessary, according to the performance and efficiency. This makes it possible to provide a flat panel display device with low power consumption.

The voltage reached by LC resonance is lower than the sustain discharge voltage Vs in the power recovery operation in the conventional art due to the loss in the circuit, whereas the resonance reference voltage is set to the voltage Vs in this embodiment, whereby the sustain discharge voltage Vs is reached with a delay of more than ¼ of the resonance cycle even if there are some losses in the circuit. Therefore, the switching element which clamps the voltage at the sustain discharge voltage Vs is turned on when the voltage reaches the sustain discharge voltage Vs, thereby making it possible to suppress radiation noise without steep rise in the voltage to be applied to the panel capacitance Cp.

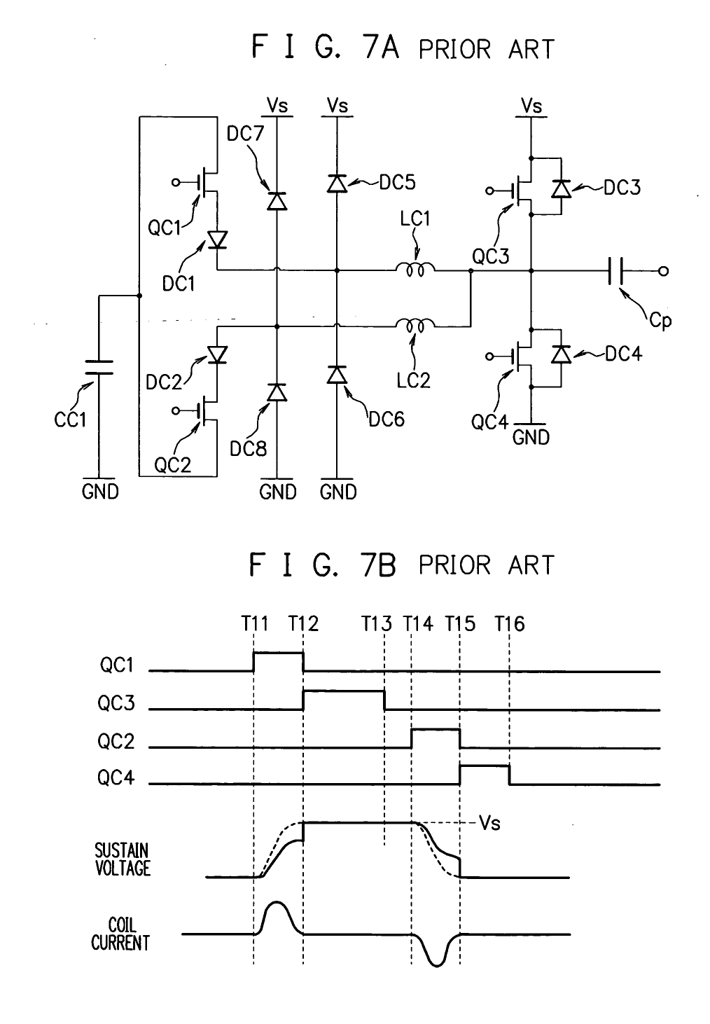

As is clear from comparison between FIG. 3 and FIG. 7A, the number of circuit elements can be reduced in this embodiment to be smaller than that in the conventional art, thus providing economic advantage and improved reliability.

Note that, in the drive circuit shown in FIG. 3, if field effect transistors are used as switching elements, their parasitic diodes may be used as the diodes DA1 to DA4 and DB1 to DB4 connected in parallel to the respective switching elements QA1 to QA4 and QB1 to QB4, and in this case further reduction in the number of circuit elements can be realized.

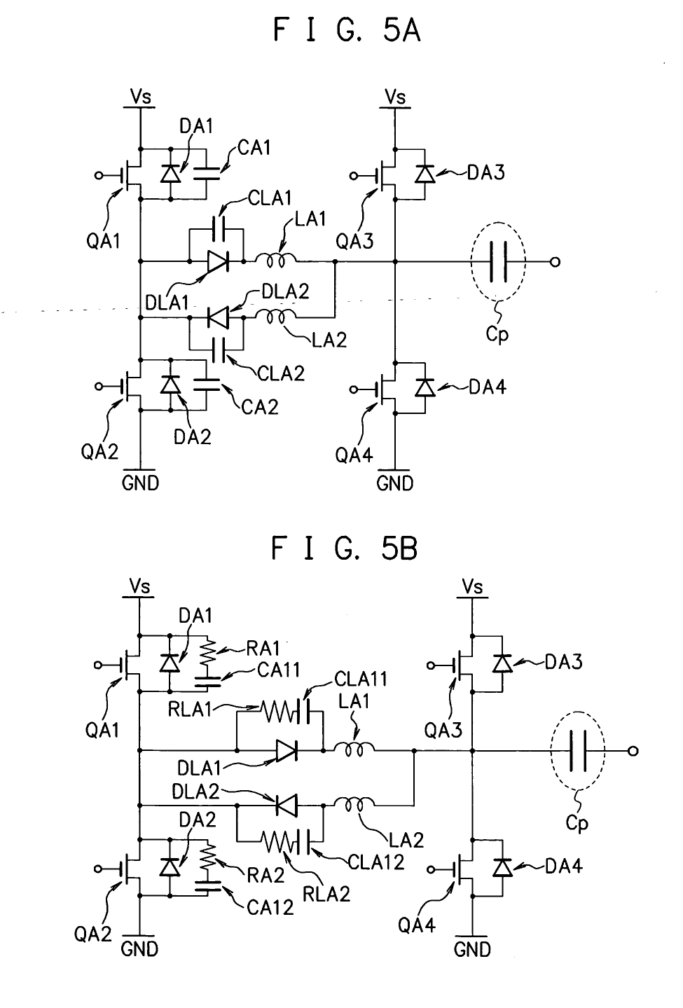

Here, as shown in FIG. 5A, capacitors CA1, CA2, CLA1, and CLA2 may be connected in parallel to the switching elements QA1 and QA2 and the diodes DLA1 and DLA2 constituting the drive circuit. Such configuration can reduce noise to prevent malfunction. As shown in FIG. 5B, in place of the capacitors CA1, CA2, CLA1, and CLA2, series circuits composed of capacitors CA11, CA12, CLA11, and CLA12 and resistors RA1, RA2, RLA1, and RLA2 may be connected in parallel to the switching elements QA1 and QA2 and the diodes DLA1 and DLA2.

Note that a capacitor or a series circuit composed of a capacitor and a resistor may be connected in parallel to all of the switching elements QA1 and QA2 and the diodes DLA1 and DLA2, or, may be selectively connected to them. Besides, FIG. 5A and FIG. 5B illustrate the Y-side drive circuit 3, and the illustration also applies to the X-side drive circuit 2.

### Second Embodiment

A second embodiment of the present invention will be described.

The second embodiment described below is different from the first embodiment only in that the sustain circuit in the drive circuits 2 and 3 is different in configuration and is the same as the first embodiment in other configuration, and therefore description thereof will be omitted.

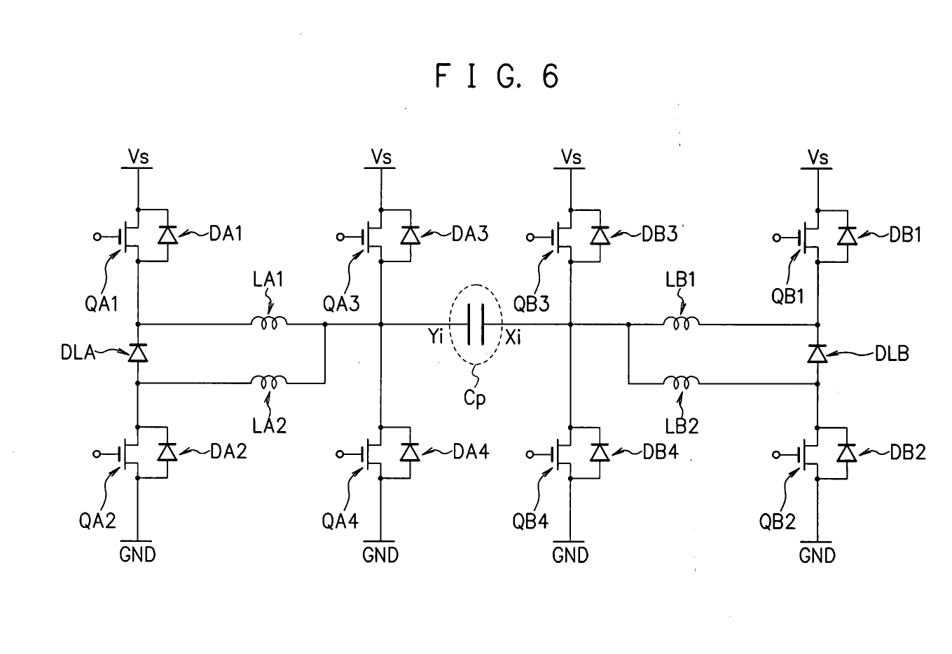

FIG. 6 is a circuit diagram of a configuration example of a sustain circuit in the X-side drive circuit 2 and the Y-side drive circuit 3 in the second embodiment. In FIG. 6, the same numerals and symbols are given to the components having the same functions as the components shown in FIG. 3 to omit overlapping description.

The circuit in the second embodiment shown in FIG. 6 is different from the circuit shown in FIG. 3 in configuration of the circuit for separating the paths through which the charge/discharge currents for the panel capacitance Cp flow. In the second embodiment, without using two diodes, one diode DLA (DLB) is connected between the charging coil LA1 (LB1) and the discharging coil LA2 (LB2) to separate the paths through which the charge/discharge currents flow.

More specifically, the diode DLA has the cathode connected to the source of the transistor QA1 and the anode connected to the drain of the transistor QA2. In other words, the source of the transistor QA1 and the drain of the transistor QA2 are connected via the diode DLA. The coil LA1 is connected in series between the interconnection point between of the cathode of the diode DLA and the source of the transistor QA1 and the Y electrode Yi. The coil LA2 is connected in series between the interconnection point between the anode of the diode DLA and the drain of the transistor QA2 and the Y electrode Yi.

Similarly, the diode DLB has the cathode connected to the source of the transistor QB1 and the anode connected to the drain of the transistor QB2. In other words, the source of the transistor QB1 and the drain of the transistor QB2 are connected via the diode DLB. The coil LB1 is connected in series between the interconnection point between the cathode of the diode DLB and the source of the transistor QB1 and the X electrode Xi. The coil LB2 is connected in series between the interconnection point between the anode of the diode DLB and the drain of the transistor QB2 and the X electrode Xi.

Also in the second embodiment configured as described above, the resonance reference voltage relating to the power recovery operation is set to maximum (voltage Vs) and minimum (0V) of the voltage to be applied to the panel capacitance Cp, and the paths (input/output paths of the recovery current) through which the charge/discharge currents flow can be separated, so that the same effect as that of the first embodiment can be obtained. Further, a single diode DLA (DLB) rather than two diodes can be used to separate the paths through which the charge/discharge currents flow, so that the number of circuit elements can be further reduced as compared to the first embodiment.

### Third Embodiment

Next, a third embodiment of the present invention will be described.

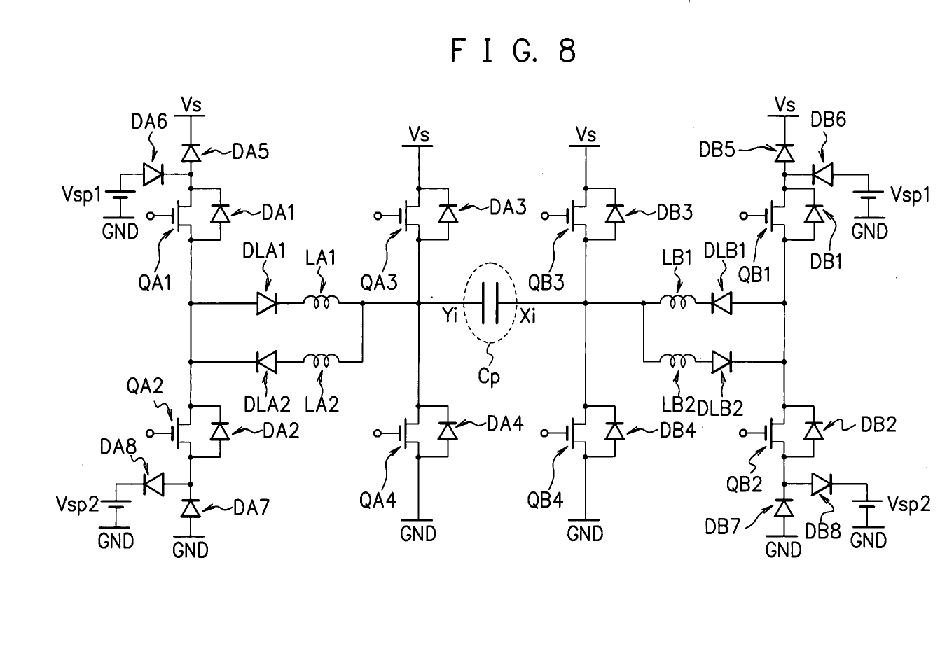

FIG. 8 is a diagram showing a configuration example of a drive circuit in the third embodiment of the present invention. In FIG. 8, the same numerals and symbols are given to the components having the same functions as the components shown in FIG. 3 to omit overlapping description. The circuit shown in FIG. 8 is different from the circuit shown in FIG. 3 in that constant voltage sources Vsp1 and Vsp2 and the diodes DA5, DA6, DA7, DA8, DB5, DB6, DB7, and DB8 are added.

In the circuit shown in FIG. 8, charges accumulated at the constant voltage source Vsp1 are supplied to the panel capacitance Cp via the diode DA6, the switching element QA1, the diode DLA1, and the coil LA1.

In the circuit shown in FIG. 8, charges accumulated at the panel capacitance Cp are supplied to the constant voltage source Vsp2 via the coil LA2, the diode DLA2, the switching element QA2, and the diode DA8.

Besides, if the potential at the connection point between the switching elements QA1 and QA2 is higher than the sustain discharge voltage Vs, the diodes DA1 and DA5 are turned on, whereas if the potential at the connection point between the switching elements QA1 and QA2 is lower than the ground level (GND), the diodes DA2 and DA7 are turned on.

The operation on the X-side (DB5, DB6, DB7, and DB8) is the same as the above.

In the circuit shown in FIG. 8, the potentials of the constant voltage sources Vsp1 and Vsp2 can be adjusted to set the gradient of the voltage to be supplied to the panel capacitance Cp and the voltage to be reached to appropriate values. Other operations and effects are the same as those of the first embodiment.

### Fourth Embodiment

Next, a fourth embodiment of the present invention will be described.

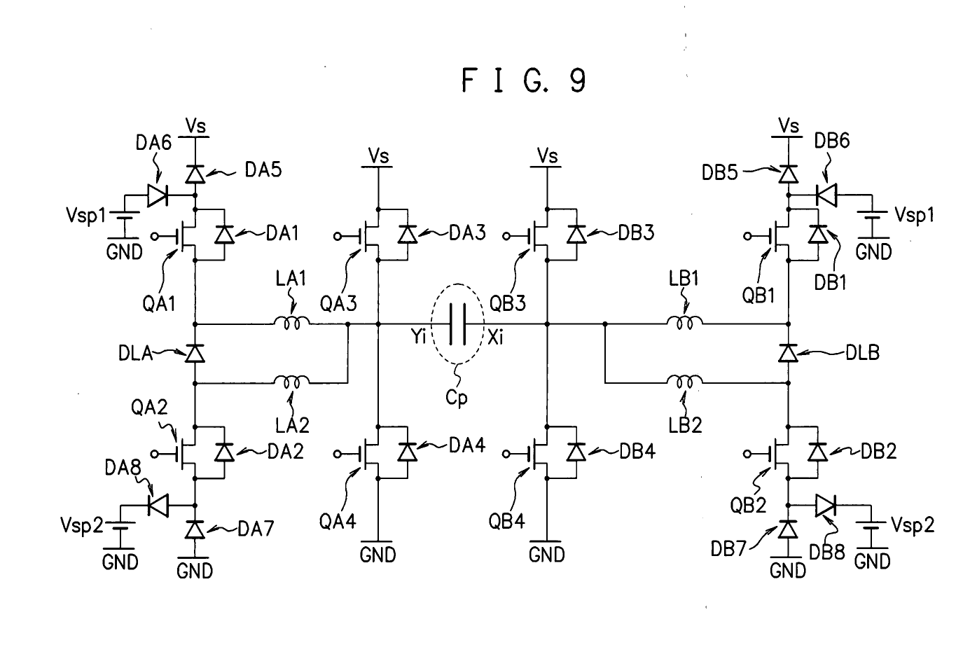

FIG. 9 is a diagram showing a configuration example of a drive circuit in the fourth embodiment of the present invention. In FIG. 9, the same numerals and symbols are given to the components having the same functions as the components shown in FIG. 6 and FIG. 8 to omit overlapping description. The drive circuit in the fourth embodiment shown in FIG. 9 serves both functions of those in the second embodiment and the third embodiment.

### Other Embodiments

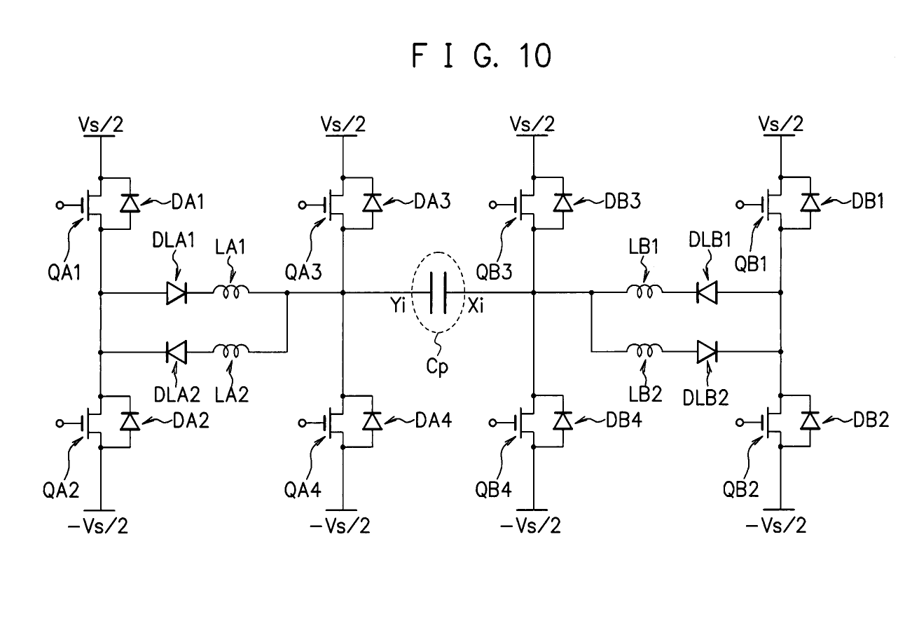

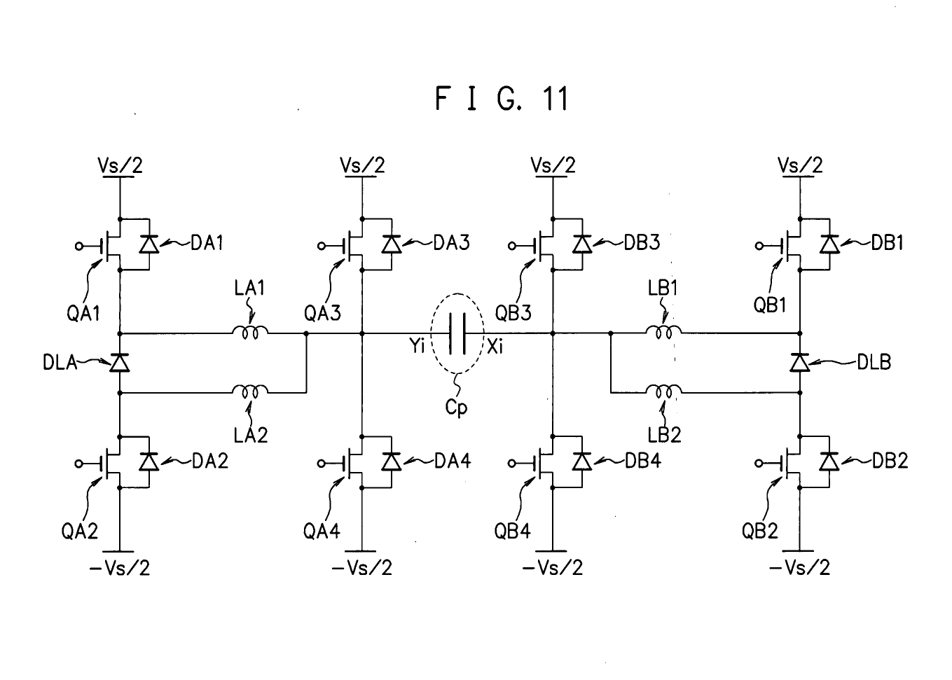

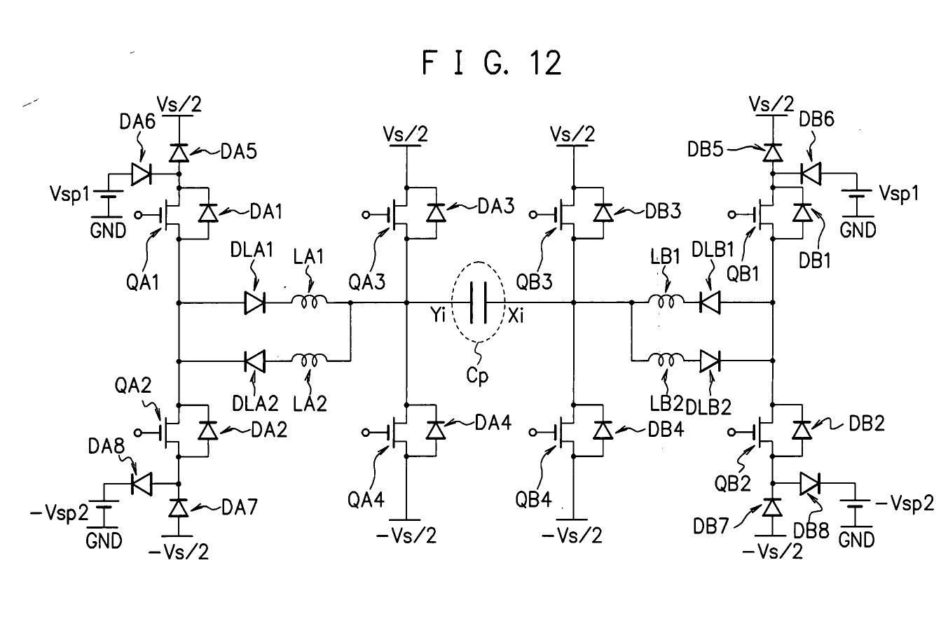

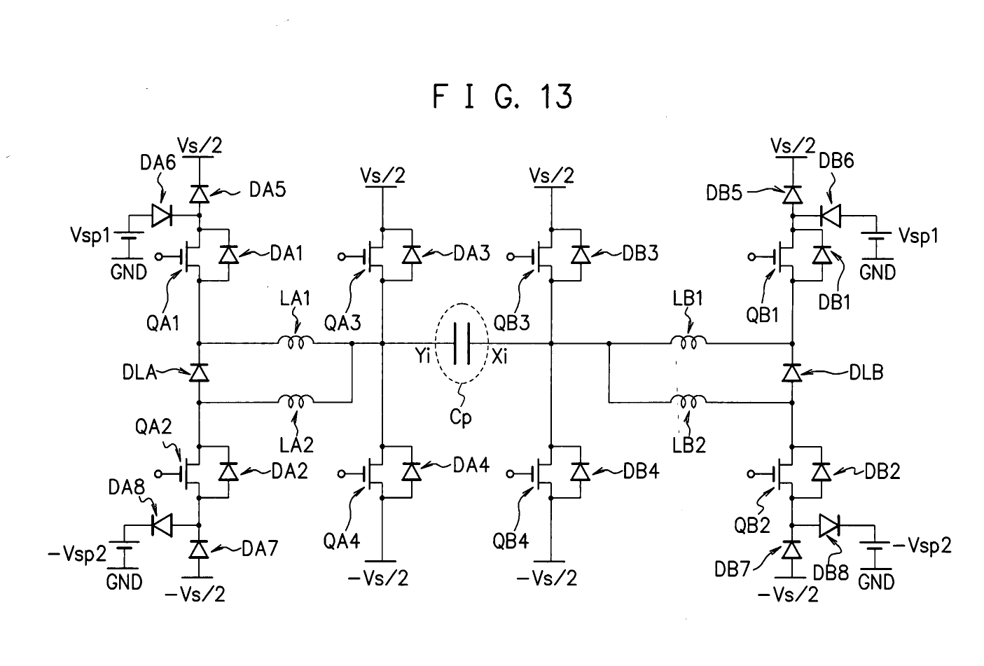

FIG. 10, FIG. 11, FIG. 12 and FIG. 13 show fifth to eighth embodiments of the present invention. In FIG. 10 to FIG. 13, the same numerals and symbols are given to the components having the same functions of the components shown in FIG. 3, FIG. 6, FIG. 8 and FIG. 9. The drive circuit in each of the fifth to eighth embodiments shown in FIG. 10 to FIG. 13 uses (+Vs/2) as the first voltage and (−Vs/2) as the second voltage in the first to fourth embodiments. Further, the drive circuit uses Vsp1 as the third voltage and (−Vsp2) as the fourth voltage.

The fifth to eighth embodiments of the present invention can be used to supply both the positive voltage and the negative voltage to the panel capacitance Cp. Accordingly, the degree of freedom of setting value of the drive voltage can be increased.

Note that while the N-channel field effect transistor is used as the switching element in the first to eighth embodiments, the switching element is not limited to that, but any circuit element is applicable which can be on/off-controlled. For example, an IGBT (Insulated Gate Bipolar Transistor) may be used as the switching element.

According to the present invention, the resonance reference voltage relating to the power recovery operation is set to a maximum voltage and a minimum voltage to be applied to the capacitive load, thereby making it possible to reach the voltage at which light emission is performed by the capacitive load when the gradient of the voltage change by LC resonance is maximum to realize stable image display. Further, even if the resonance reference voltage relating to the power recovery operation is set to a maximum voltage and a minimum voltage to be applied to the capacitive load, the paths through which the charge current and the discharge current flow can be separated so that the circuit characteristics of the power recovery circuit in voltage rise/drop are independently selected to improve the recovery efficiency.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A flat panel display device comprising:
a self-luminous display panel applying a voltage to a capacitive load being a display means to perform image display; and
a drive circuit applying a voltage to said capacitive load, said drive circuit comprising:
a first switching element, connected to a first voltage being a maximum voltage to be applied to said capacitive load when performing light emission relating to the image display, for clamping an electrode of said capacitive load to the first voltage;
a second switching element, connected to a second voltage being a minimum voltage to be applied to said capacitive load when performing light emission relating to the image display, for clamping the electrode of said capacitive load to the second voltage;
a first coil having one end connected to an interconnection point between said first switching element and the electrode of said capacitive load;
a second coil having one end connected to an interconnection point between said second switching element and the electrode of said capacitive load;
a path separation circuit, connected to other ends of said first coil and said second coil, for separating paths through which charge/discharge currents flow;
a third switching element connected between the first voltage and said path separation circuit;
a fourth switching element connected between the second voltage and said path separation circuit; and
a first to a fourth diode respectively corresponding to said first to fourth switching elements and connected in parallel to said switching elements.

2. The flat panel display device according to claim 1,
wherein said path separation circuit comprises:
a fifth diode having a cathode connected to the other end of said first coil; and
a sixth diode having an anode connected to the other end of said second coil,
wherein said third and fourth switching elements are connected to an interconnection point between an anode of said fifth diode and a cathode of said sixth diode.

3. The flat panel display device according to claim 2,
wherein a capacitor or a series circuit composed of a capacitor and a resistor is connected in parallel at least to one of said fifth and sixth diodes.

4. The flat panel display device according to claim 1,
wherein said path separation circuit comprises:
a fifth diode having a cathode connected to the other end of said first coil and an anode connected to the other end of said second coil, and
wherein said third switching element is connected to the cathode of said fifth diode, and said fourth switching element is connected to the anode of said fifth diode.

5. The flat panel display device according to claim 4,
wherein a capacitor or a series circuit composed of a capacitor and a resistor is connected in parallel to said fifth diode.

6. The flat panel display device according to claim 1,
wherein an inductance of said first coil is less than an inductance of said second coil.

7. The flat panel display device according to claim 1,
wherein when the first voltage is applied to the electrode of said capacitive load, said third switching element is turned on to start power supply to said capacitive load by resonance of said capacitive load and said first coil, and turned off after a lapse of ¼ cycle of the resonance cycle from the start of supply with a predetermined time delay.

8. The flat panel display device according to claim 1,
wherein a capacitor or a series circuit composed of a capacitor and a resistor is connected in parallel at least to one of said third and fourth switching elements.

9. The flat panel display device according to claim 1,
wherein said first to fourth diodes are parasitic diodes of said first to fourth switching elements.

10. The flat panel display device according to claim 1,
wherein said display panel is a plasma display panel, and
wherein the first voltage is a sustain discharge voltage for performing the image display.

11. The flat panel display device according to claim 1,
wherein a fifth, a sixth, a seventh, and an eighth switching element and a third voltage and a fourth voltage set between the first voltage and the second voltage are provided,
wherein one end of said third switching element is connected to the first voltage via said fifth switching element,
wherein said sixth switching element is provided between a connection point between said third switching element and said fifth switching element and the third voltage,
wherein one end of said fourth switching element is connected to the second voltage via said seventh switching element, and
wherein said eighth switching element is provided between a connection point between said fourth switching element and said seventh switching element and the fourth voltage.

12. The flat panel display device according to claim 11,
wherein said fifth switching element is a diode having an anode connected to said third switching element and a cathode connected to the first voltage,
wherein said sixth switching element is a diode having an anode connected to the third voltage and a cathode connected to the connection point between said third switching element and said fifth switching element,
wherein said seventh switching element is a diode having an anode connected to the second voltage and a cathode connected to said fourth switching element, and
wherein said eighth switching element is a diode having a cathode connected to the fourth voltage and an anode connected to the connection point between said fourth switching element and said seventh switching element.

13. The flat panel display device according to claim 4,
wherein a fifth, a sixth, a seventh, and an eighth switching element and a third voltage and a fourth voltage set between the first voltage and the second voltage are provided,
wherein one end of said third switching element is connected to the first voltage via said fifth switching element,
wherein said sixth switching element is provided between a connection point between said third switching element and said fifth switching element and the third voltage,
wherein one end of said fourth switching element is connected to the second voltage via said seventh switching element, and
wherein said eighth switching element is provided between a connection point between said fourth switching element and said seventh switching element and the fourth voltage.

14. The flat panel display device according to claim 13,
wherein said fifth switching element is a diode having an anode connected to said third switching element and a cathode connected to the first voltage,
wherein said sixth switching element is a diode having an anode connected to the third voltage and a cathode connected to the connection point between said third switching element and said fifth switching element,
wherein said seventh switching element is a diode having an anode connected to the second voltage and a cathode connected to said fourth switching element, and
wherein said eighth switching element is a diode having a cathode connected to the fourth voltage and an anode connected to the connection point between said fourth switching element and said seventh switching element.

15. The flat panel display device according to claim 1,
wherein the first voltage is (+Vs/2), and the second voltage is (−Vs/2).

16. The flat panel display device according to claim 4,
wherein the first voltage is (+Vs/2), and the second voltage is (−Vs/2).

17. The flat panel display device according to claim 1,
wherein the first voltage is (+Vs/2), and the second voltage is (−Vs/2),
wherein a fifth, a sixth, a seventh, and an eighth switching element and a third voltage and a fourth voltage set between the first voltage and the second voltage are provided,
wherein one end of said third switching element is connected to the first voltage via said fifth switching element,
wherein said sixth switching element is provided between a connection point between said third switching element and said fifth switching element and the third voltage,
wherein one end of said fourth switching element is connected to the second voltage via said seventh switching element, and
wherein said eighth switching element is provided between a connection point between said fourth switching element and said seventh switching element and the fourth voltage.

18. The flat panel display device according to claim 17,
wherein said fifth switching element is a diode having an anode connected to said third switching element and a cathode connected to the first voltage,
wherein said sixth switching element is a diode having an anode connected to the third voltage and a cathode connected to the connection point between said third switching element and said fifth switching element,
wherein said seventh switching element is a diode having an anode connected to the second voltage and a cathode connected to said fourth switching element, and
wherein said eighth switching element is a diode having a cathode connected to the fourth voltage and an anode connected to the connection point between said fourth switching element and said seventh switching element.

19. The flat panel display device according to claim 4,
wherein the first voltage is (+Vs/2), and the second voltage is (−Vs/2),
wherein a fifth, a sixth, a seventh, and an eighth switching element and a third voltage and a fourth voltage set between the first voltage and the second voltage are provided,
wherein one end of said third switching element is connected to the first voltage via said fifth switching element,
wherein said sixth switching element is provided between a connection point between said third switching element and said fifth switching element and the third voltage,
wherein one end of said fourth switching element is connected to the second voltage via said seventh switching element, and
wherein said eighth switching element is provided between a connection point between said fourth switching element and said seventh switching element and the fourth voltage.

20. The flat panel display device according to claim 19,
wherein said fifth switching element is a diode having an anode connected to said third switching element and a cathode connected to the first voltage,
wherein said sixth switching element is a diode having an anode connected to the third voltage and a cathode connected to the connection point between said third switching element and said fifth switching element,
wherein said seventh switching element is a diode having an anode connected to the second voltage and a cathode connected to said fourth switching element, and
wherein said eighth switching element is a diode having a cathode connected to the fourth voltage and an anode connected to the connection point between said fourth switching element and said seventh switching element.
